(19) United States
(12) Patent Application Publication
(10) Pub. No.: US 2014/0129372 A1
(43) Pub. Date: May 8, 2014

(54) METHODS AND SYSTEMS FOR TRAVEL RECOMMENDATIONS

(71) Applicant: DYNAMIC VACATIONS, INC. DBA BEACHSCAPE, Atlanta, GA (US)

(72) Inventor: Shaun Kalnsay, West Hills, CA (US)

(73) Assignee: DYNAMIC VACATIONS, INC. DBA BEACHSCAPE, Atlanta, GA (US)

(21) Appl. No.: 13/670,329

(22) Filed: Nov. 6, 2012

(51) Int. Cl. G06Q 30/06; G06Q 50/14

(52) U.S. Cl. CPC G06Q 30/0631; G06Q 50/14
USPC 705/26.7

(57) ABSTRACT

Methods and systems for travel recommendations, in particular, such methods and systems as provide ranked recommendations that take into account user-specified preferences in a plurality of categories and which include both transparent and opaque results. The ranked recommendations may include both transparent and opaque results and may be determined using user-specified destinations and one or more of: user activity or amenity preferences, room amenity and room type preferences, accommodation quality preferences, and preferred travel dates. Optionally, flight preference information may also be used in computing the ranked results. The rankings may involve weighted scorings that limit emphasis on potential outlier accommodation properties deemed to be substantially different from a user's specified preferences in one or more such categories.

### FIELD OF THE INVENTION

The present invention relates to methods and systems for travel recommendations and, in particular, to such methods and systems as provide ranked recommendations that take into account user-specified preferences in a variety of categories and which include both transparent and opaque results.

### BACKGROUND

A number of websites devoted to helping users plan leisure travel currently exist. These sites can generally be divided among online travel agency (OTA) sites, meta search sites, specialty and discount sites, and vendor-operated sites. Some sites within these categories will provide transparent results (i.e., results which indicate to the user the identity of the carrier and/or accommodation provider prior to purchase), while others provide (in addition to or instead of the transparent results) opaque results (i.e., results which do not reveal the identity of the carrier and/or accommodation provider to the user prior to purchase). Nevertheless, all such sites have various flaws that make them problematic for users who are seeking recommendations regarding potential travel destinations and accomodations, especially where leisure travel is concerned.

Consider, for example, that OTAs generally allow users to book flight and/or accommodations but require that the user know where he/she wants to travel from/to. For example, to book a flight using an OTA site, a user must generally specify both departure and destination airports and identify travel dates or date ranges. Similarly, to book accommodations a user must typically specify a metropolitan area or similar destination along with dates of stay. No tools are provided to help users discover possible destinations of interest. This is problematic because many (indeed, perhaps most) leisure travelers do not know exactly where they want to go and/or exactly where they want to stay.

Meta search sites are similar to OTAs in that they require users to specify departure and destination airports, travel dates or date ranges, and/or desired metropolitan areas or destinations before returning search results. While the meta search sites do offer the benefit of invoking a search (once the appropriate criteria have been entered) across multiple travel sites, they do not allow a user to complete a purchase at that site. Instead, the user is redirected to the particular travel site or vendor site from which the search result was obtained and must complete a transaction using that site's interface and tools.

Specialty sites too follow the OTA search and purchase model, although they may offer better pricing and reviews (e.g., past visitor reviews) for specific travel destinations that the OTA sites. Of course, a user must already know that he/she is interested specifically in the kind of leisure travel offered through the specialty site before it is of any use. Hence, the specialty sites are not very useful for users seeking recommendations that may encompass a variety of travel destinations. Likewise, the vendor-specific sites are only useful for travelers who know they want to use a specific airline and/or accommodation and will not typically offer any recommendation regarding competitors.

Virtually all of the above site types offer transparent search results to their users. That is, users are permitted to see the airline/accommodation details prior to purchase. Such purchases often are not offered at any discounts (at least not significant discounts), however, because all of the providers have a vested interest in not diluting their rates. Not everyone can afford or is willing to pay these rates, however, and so flights and accommodations are sometimes offered through travel sites without revealing the identities of the carriers/accommodation providers to the user prior to purchase. Such “opaque” results are popular with business travelers seeking to minimize expenses, however, leisure travels are often hesitant to purchase same. Because the opaque results are often presented only in terms of their pricing and without other contextual information, leisure travelers may fear that the flights/accommodations so offered will be uncomfortable or unappealing and therefore may negatively impact what is intended to be a pleasure trip. Consequently, the prospective traveler is unwilling to risk the purchase and so may miss out on what could be a significant savings over the transparent search result.

Some travel sites provide users with results ranked according to price. Typically, the least expensive flights/rooms are shown first in a ranked list. Often, however, this list is assembled without regard to any user preferences and, even if some preferences are accounted for, comparing prices across different searches (even at the same travel site) is made very difficult because there is no way to know exactly what room/flight type/characteristics are common across different properties/airlines. Assuming that a user is interested only in the least expensive room/flight is a rather unscientific way to present search results and only increases to the time required for users to try and make travel decisions. This leads to user frustration and may actually impair (rather than enhance) the ability to sell the user a vacation package.

### SUMMARY OF THE INVENTION

In various embodiments, methods and systems for providing accommodation recommendations are provided. Such recommendations are preferably provided in response to user-specified criteria, and may be provided in the form of a ranked list of accommodation recommendations. The ranked list of accommodation recommendations may include both transparent and opaque accommodation property results, individual ones of the opaque accommodation property results differing from individual ones of the transparent accommodation property results by not including property-identifying information.

In various instances, the ranked list of accommodation recommendations may be determined using user-specified destinations and one or more of: user activity or amenity preferences, room amenity and room type preferences, accommodation quality preferences, travel budget, and preferred travel dates, the server scoring accommodation properties within identified sub-destinations of the one or more user-specified destinations according to one or more of the user activity or amenity preferences, the room amenity and room type preferences, the accommodation quality preferences, travel budget considerations, and availabilities during the preferred travel dates. Optionally, flight preference information may also be used in computing the ranked list of results.

Scoring of the accommodation properties in different categories may involve weighted scorings that limit emphasis on potential outlier accommodation properties deemed to be substantially different from a user's specified preferences in one or more such categories. Further, the opaque accommodation property results included in the ranked list may be accompanied by categorized scores for one or more of the user activity or amenity preferences, the room amenity and room type preferences, and the accommodation quality preferences, thus acting as enticements for users to trust and, possibly purchase, said results.

These and further embodiments of the present invention are discussed in detail below.

### BRIEF DESCRIPTION OF THE DRAWINGS

The present invention is illustrated by way of example, and not limitation, in the figures of the accompanying drawings in which:

FIG. 1 illustrates a process for providing travel recommendations and, in particular, ranked recommendations that take into account user-specified preferences in a variety of categories and which include both transparent and opaque results, in accordance with an embodiment of the present invention;

FIG. 2 illustrates a process similar to that illustrated in FIG. 1 and which takes into account airline flight preferences of a user, in accordance with a further embodiment of the present invention;

FIG. 3 illustrates an example of a process for scoring candidate accommodations on the basis of room rates, in accordance with an embodiment of the present invention;

FIG. 4 illustrates an example of a process for scoring candidate accommodations on the basis of room type and/or view, in accordance with an embodiment of the present invention;

FIG. 5 illustrates an example of a process for scoring candidate accommodations on the basis of the number of bedrooms in a room, in accordance with an embodiment of the present invention;

FIG. 6 illustrates examples of various data tables useful in computing ranked accommodation results, in accordance with an embodiment of the present invention;

FIG. 7 illustrates an example of computer system for accessing a server from which travel recommendations produced in accordance with embodiments of the present invention can be obtained;

FIG. 8 illustrates an example of a computer network which includes a server hosting a travel recommendation website configured in accordance with an embodiment of the present invention;

FIGS. 9 and 10 illustrates examples of a computer system suitable for executing processes for making travel recommendations in accordance with an embodiment of the present invention;

FIG. 11 illustrates an example of a user interface for soliciting user preference information in accordance with embodiments of the present invention;

FIG. 12 illustrates an example of a user interface showing a portion of a ranked list of accommodation properties returned to a user as search results in accordance with an embodiment of the present invention; and

FIG. 13 illustrates an example of a user interface for providing detailed accommodation property score information in one or more user-specified categories.

### DETAILED DESCRIPTION

Recognizing the problems that exist with conventional travel websites, the present inventors have developed, and herein describe, methods and systems for travel recommendations and, in particular, such methods and systems as provide ranked recommendations that take into account user-specified preferences in a plurality of categories and which include both transparent and opaque results.

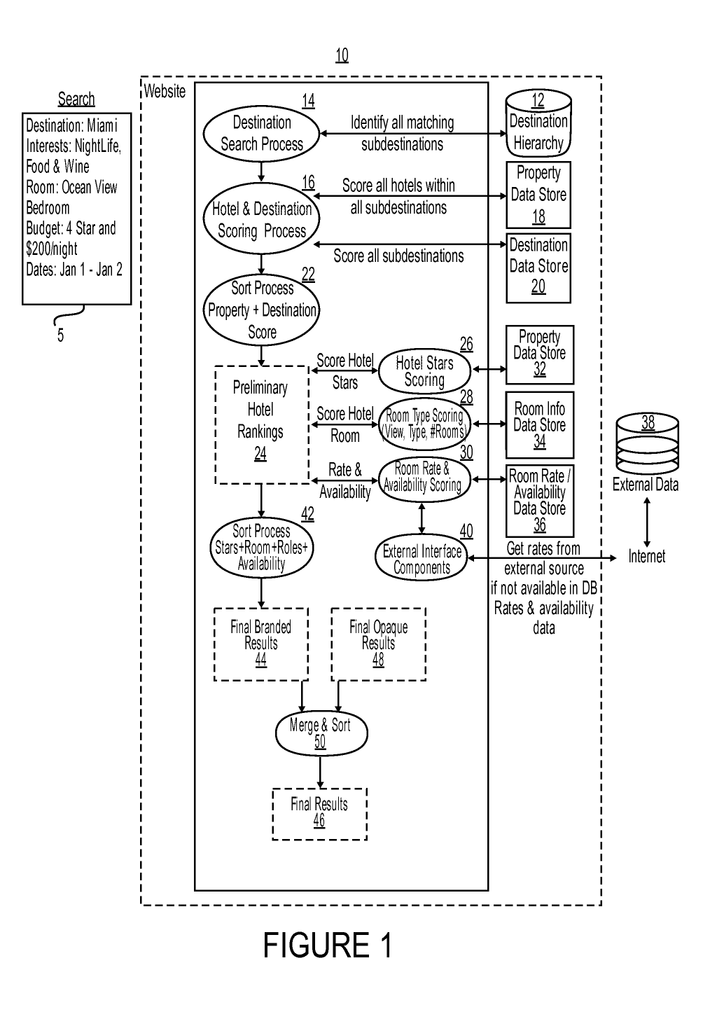

In one embodiment of the present invention, illustrated graphically in FIG. 1, recommended vacation accommodation properties are determined in a multi-step process 10 that takes into account user-specified destinations and one or more of user activity or amenity preferences, room amenity and room type preferences, accommodation quality and budget preferences, and preferred travel dates. Such preference information may be solicited through a web page interface as is common in the online travel site industry. Thus, users may visit (e.g., via a computer system running a web browser application) a host (e.g., a server accessible through the Internet or other computer network or network of networks) at which a software instantiation of a method embodying the present invention is running, and engage in travel planning discovery activities aimed at providing travel recommendations that best align with the user's specified preferences. As discussed further below, flight preference information may also be solicited and taken into account.

For each user-specified destination 5 (of which more than one may be indicated at a time), and here destinations may be specified at a virtually any level of granularity (including simply an indication to travel somewhere in the world), a plurality of corresponding sub-destinations are identified from a destination database 12. By sub-destinations, we mean a distinct area, location, neighborhood or other identifiable geographical, cultural, or community-recognized locale within a larger city, metropolis, county, state, province, region, or country, etc. For example, the city of Miami and its surroundings, a popular vacation destination, may have many different sub-destinations associated with it, including but not limited to South Beach, Coral Gables, Downtown, Little Haiti, Little Havana, the Venetian Islands, the Keys, etc.

For each corresponding sub-destination identified in the destination search 14, an accommodation and destination scoring process 16 is executed. In this procedure, accommodation properties associated with each of the identified sub-destinations are retrieved from a data store 18 and scored according to the user-specified activity or interest preferences. Likewise, the sub-destinations themselves are scored according to the user-specified activity or interest preferences based on information retrieved from a destination data store 20. This results in respective, preliminary accommodation property and sub-destination scores. Separate scoring of accommodation properties and sub-destinations is useful because, while some user-interests may cross-over both of these categories (e.g., both accommodation properties and sub-destinations may be rated according to “food and wine” interests), others are specific to only one or the other (e.g., shopping is really a sub-destination interest and not one typically associated with a hotel or other accommodation property). Therefore, to account for a wide variety of possible user-specified interests, both are scored.

Based on the preliminary accommodation property and sub-destination scores the accommodation properties are sorted 22 to produce preliminary accommodation rankings 24. Depending on the particular sub-destinations involved, there may be a significant number of potential accommodation properties included in this preliminary list. In order to keep processing time minimized and a final results list to manageable number for a given user, this preliminary list of accommodation properties is reduced to a threshold number. This number may vary depending upon the destination and/or the implementation, but in some instances may be no more than 100 accommodation properties, no more than 80 accommodation properties, no more than 50 accommodation properties, no more than 25 accommodation properties, no more than 10 accommodation properties or no more than a user-specified number of accommodation properties. Where the present system is access through a meta search or other third party facility, the number of preliminary results may be increased over that which would otherwise be the case, or in some instances may be less than that which would otherwise be the case. Further, in some instances, when accessed through meta search or other facilities, the present system may exclude some accommodation properties or types of properties from the preliminary list.

For the plurality of accommodation properties of the preliminary accommodation rankings, each respective accommodation property is then scored according to one or more of the room amenity/room type 28 preferences, accommodation quality preferences 26, and room rate preferences and availability during the preferred travel dates 30. In each case, scoring is based on information obtained from respective accommodation property data stores 32, room information data stores 34 and room rate and availability information data stores 36. In cases where information in the room rate and availability information data store 36 may be out of date (e.g., more than a specified number of hours or days old), updated information may be obtained directly from external data sources (such as vendor databases or third party aggregator databases) 38 through interfaces 40 to such data sources. Based on the combined results of these scoring processes, the plurality of accommodation properties of the preliminary list are sorted into ranked order 42. These final accommodation property rankings 44 may again be reduced to a manageable number of results under the circumstances, for example, no more than 40 accommodation properties, no more than 20 accommodation properties, no more than 10 accommodation properties, or no more than a user-specified number of accommodation properties, and presented for user review and selection 46.

In some instances, the final ranked list of accommodation properties will include only transparent results. However, in other instances, the final ranked list of accommodation properties will include both transparent and opaque results in a merged list. Thus, as illustrated in FIG. 1, process 10 may include with the final accommodation property rankings 44, a set of final opaque accommodation property results 48, individual ones of the opaque accommodation property results differing from individual ones of the final accommodation property rankings by not including property-identifying information. The final opaque accommodation property results 48 may be arrived at in the same fashion as was described above for the final accommodation property rankings 44 and the two sets of results merged and sorted 50 into a final ranked list for presentation to the user.

The rankings in either or both sets of final ranked lists is based on the scores determined during each of the above-described scoring processes, with a final score being determined in any of several ways. For example, a final score may be determined by simply aggregating the scores from the individual scoring steps. Or, the final score may be a weighted sum of the individual category scores, with weightings for each category being predetermined or user selectable. With respect to this latter instance, the user may be able to dynamically modify the final ranked results by varying (e.g., through use of an on-screen slider tool or other widget) the relative weightings assigned to each category score to see how, for example, property results vary when room type scores are weighted more heavily that room rate scores or vice-versa, for example. Of course, many other types of dynamic weighting modifications may be provided and this example is not intended as being a limiting one.

It is not a requirement of the present invention that users specify preferences in each and every category for which results (preliminary or otherwise) may be scored. An aspect of discovery facilitated through the present invention is the ability for users to leave open many possible categories of constraints (e.g., room type, room budget, travel dates, etc.) and still receive recommendations. In some embodiments of the invention, even destinations need not be specified, in which instance systems configured in accordance with the invention will assume the user is open to traveling anywhere in the world. While not all preference categories need user selections, it is useful if the user provides at least one selection (from any category) otherwise the results returned to the user may have little or no meaning for the user.

Where both transparent and opaque results are returned from a search, individual ones of the final opaque accommodation property results may be presented in ranked order along with individual ones of the final accommodation property rankings in a unified list. Unlike systems which return only opaque results, however, here it is expected that users will have more confidence in the opaque results because even though the accommodation property identities are not revealed until after a purchase, the user is given information that helps in his/her understanding of why an accommodation property was selected. For example, the results (both transparent and opaque) may be returned along with their individual category scores (or an aggregate score). This allows the user to assess for him/herself how well the accommodation property meets or does not meet his/her desires and preferences. By providing this information, and in particular by providing it for both the transparent and opaque results in a single, unified list, a sense of trust is engendered between the user and the recommendation site, and so the user may be more likely to purchase a stay at a property even without know which property it is.

As indicated above, the final opaque accommodation property results may be determined in same manner as the transparent accommodation property results. That is, the system may identify, for the user-specified destinations, corresponding sub-destinations from the destination database, then for each corresponding sub-destination, score the sub-destination and a plurality of accommodation properties having opaque listings within each sub-destination according to the user activity or amenity preferences to produce a preliminary opaque accommodation property score. The opaque accommodation properties may be sorted according to respective opaque accommodation property scores to produce preliminary opaque accommodation property rankings, and for a plurality of opaque accommodations of the opaque accommodation property rankings, respective opaque accommodation properties may be scored according to one or more of the room amenity and room type preferences, accommodation quality preferences, and availability during the preferred travel dates. The results of these scorings may be aggregated or otherwise combined to produce the final opaque accommodation property results and individual ones of the final opaque accommodation property results presented in ranked order along with individual ones of the final accommodation property rankings in the unified list.

In some instances, the scorings of accommodation properties involves weighted scorings, which limit emphasis on potential outlier accommodation properties that are deemed to be substantially different from a user's specified preferences in one or more categories. That is, individual category scores may be capped or otherwise limited so as to diminish or temper their influence on overall accommodation property scores when determining the final rankings. Consider, for example, that users who specify a budget of $500 per night for a hotel room may expect a certain level of service, amenities, etc., which may not be available in a hotel that charges only $200 per night. Consequently, while the $200 per night charge represents a price far lower than the user's specified budget, it should not be given so much weight that it dominates a recommendation as the underlying property may be one which the user is not really willing to consider. Likewise, a property that charges $525 per night should not be ruled out simply because it exceeds the user's $500 per night budget as it may represent a room that exceeds the user's expectations in other areas and for which he/she is willing to pay extra. At the same time, the score need to reflect the fact that it is outside of the user's specified budget. Hence, the computation of individual category scores involves a balancing that takes into account such factors.

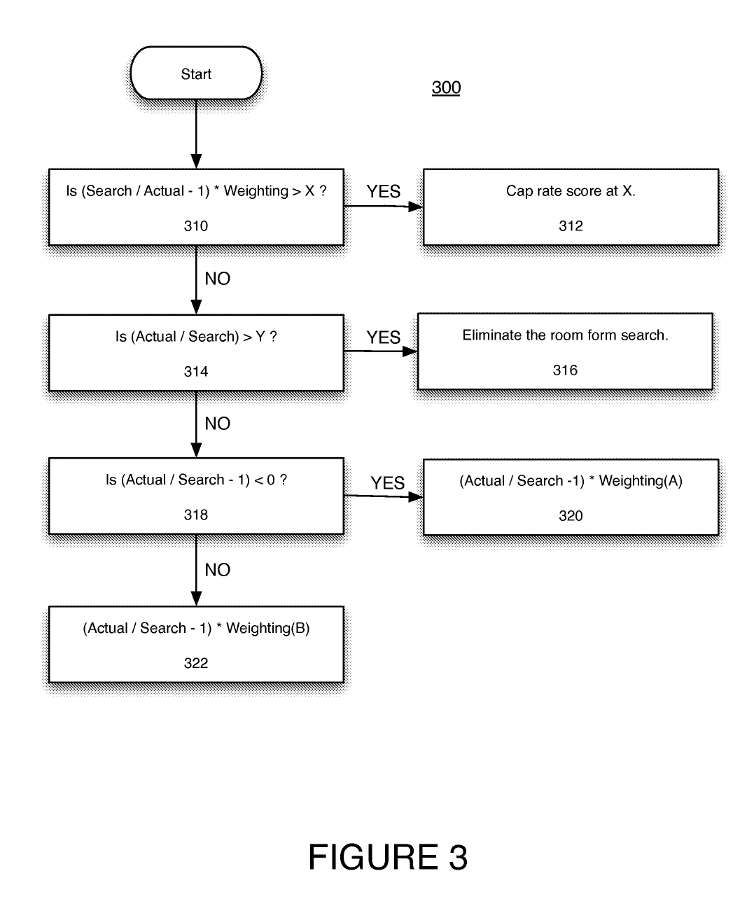

Examples of these balanced approaches for computing category scores are reflected in the flow diagrams of FIGS. 3-5. It should be appreciated that the examples illustrated in these diagrams are intended merely for purposes of explanation and the present invention is not limited to the specific algorithms, weighting factors, or scores depicted therein. In various instantiations of the present methods, more or different algorithms may be used and, as indicated above, in some cases users may be able to dynamically alter weightings applied in one or more of the category scores so as to influence the end recommendation results.

FIG. 3 illustrates an example of the computation of a score for an accommodation property room rate. In general, this scoring involves determining, for each respective candidate accommodation property, whether a weighted ratio of a desired rate for a specified amenity and room type preference to an actual rate for the specified amenity and room type preference exceeds a first predetermined threshold and, if so, capping an associated score for amenity and room type preference for the respective candidate accommodation property at the threshold. Otherwise, if the first predetermined threshold is not exceeded, the process continued by determining for the respective candidate accommodation property whether a ratio of the actual rate for the specified amenity and room type preference to the desired rate for a specified amenity and room type preference exceeds a second predetermined threshold and, if so, eliminating the respective candidate accommodation property from consideration. Otherwise, if the second predetermined threshold is not exceeded, the process continues by determining, for the respective candidate accommodation property, whether a normalized ratio of the actual rate for the specified amenity and room type preference to the desired rate for a specified amenity and room type preference is less than a third predetermined threshold and, if so, using a first weighted version of the normalized ratio of the actual rate for the specified amenity and room type preference to the desired rate for a specified amenity and room type preference as a score for the respective candidate accommodation property, otherwise using a second weighted version of the normalized ratio of the actual rate for the specified amenity and room type preference to the desired rate for a specified amenity and room type preference as a score for the respective candidate accommodation property.

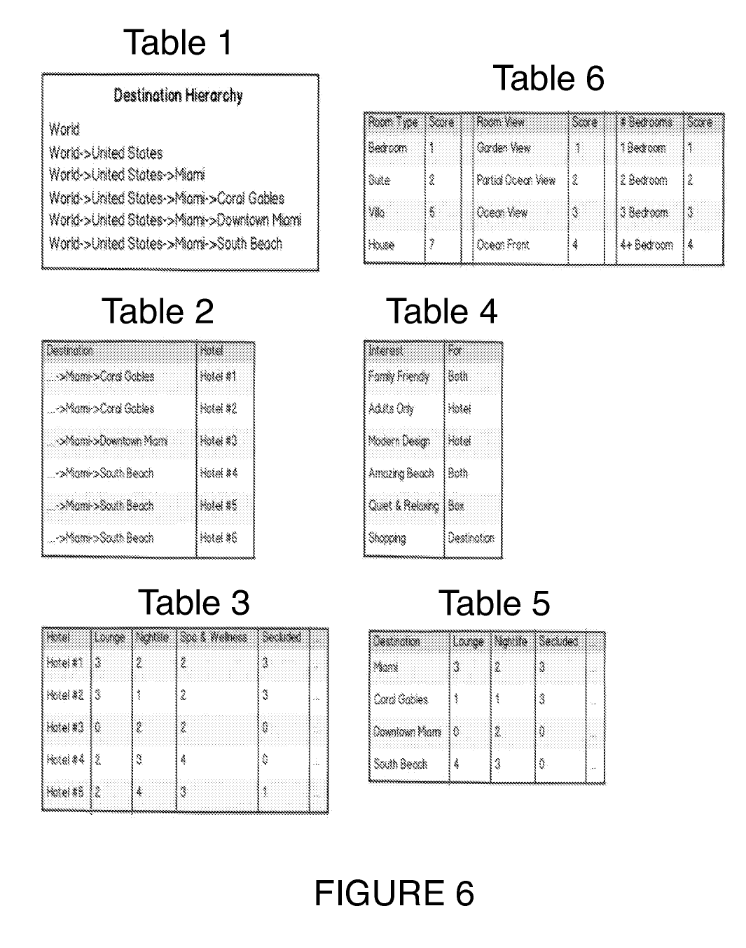

To better understand this process, refer first to the tables shown in FIG. 6. These tables are intended as examples of the kind of information stored in the destination hierarchy database 12 (Tables 1 and 2), the property and destination data stores 18 and 20 (Tables 3 and 5, respectively), and the accommodation property room data store 34 (Table 6). Table 4, which illustrates how user interests may pertain to an accommodation property, a destination/sub-destination or both, need not necessarily be an actual table stored in one of the data stores or databases discussed herein, but is provided for convenience of the reader. Table 1 represents the hierarchy between user-specified destinations and sub-destinations that should be considered in response thereto. That is, in database 12, a mapping is established so that for any user-specified destination, one or more sub-destinations (which in some instances may simply be the user-specified destination itself) are referenced. Based on these sub-destinations, accommodation properties may be identified from mappings (sub-destination to accommodation properties) stored in Table 2.

Tables 3 and 5 then list assigned numeric values for various user interests on a per property (Table 3) or per sub-destination (Table 5) basis. These numeric values are initially determined by a service provider through which the present recommendation service is offered, but may be adjusted in response to user feedback regarding search results. For example, if a user indicates that the ranked search results provided in response to a search request were in line with the user's desires (e.g., that recommended properties did meet the user's expectations in terms of expressed interests, rates, room types, etc.), then the category numeric values for the properties and/or sub-destinations may be left as is. However, if users indicate that search results were not in line with their expectations or desires, the numeric values in one or more categories for the properties and/or sub-destinations may be adjusted in an attempt to produce better results. The individual category numeric values are shown as integers, but this is merely an example. In other instances, decimal numbers may be used in order to provide finer-grained distinctions between properties/sub-destinations.

Table 6, which is of particular relevance for the processes illustrated in FIGS. 3-5, shows numeric values for rooms in various categories (type, view, number of bedrooms, etc.). Again, the quantum of the numeric values may be initially determined by the service provider through which the present recommendation service is offered, but may be adjusted in response to user feedback regarding search results. Also, the numeric values may be integers (as shown) or decimal numbers.

Returning to FIG. 3, a process 300 for scoring candidate rooms according to their daily rates is shown. Assume for purposes of example that a user has entered a search query that indicates a budget of $500 per night for a room. At 310, for each candidate room, a ratio of the room rate specified as part of the user's search query to the actual room rate for the candidate room (the search-to-actual ratio for the room rate) is computed, the value 1 subtracted therefrom, and the result multiplied by a weighting factor to produce a weighted search-to-actual room rate factor. The value of the search-to-actual room rate factor is compared to a threshold value, X, to determine if it is greater than X. This would be an indication that the actual cost of the candidate room is less than the budgeted amount by more than a determined threshold past which no greater influence of the room rate should be accorded in determining the room rate score. Hence, when this condition is met, the room rate score is capped at the threshold value at step 312.

If the capping condition is not met, the process proceeds to 314, where the ratio of the actual room rate for the candidate room to the room rate specified as part of the user's search query (the actual-to-search ratio for the room rate) is computed and a determination made to see whether this value is greater than a second threshold value, Y. If so, the candidate room is eliminated from consideration at 316. The intent here is exclude those rooms that are significantly (as determined by the value of Y) more than the budget amount specified by the user.

If the actual-to-search ratio for the room rate does not exceed Y, then process 300 continues to step 318 where a determination as to whether the value of the actual-to-search room rate ratio minus 1 is less than zero. If so, then at 320 the score for the room rate is set equal to a first weighted factor of this value. This will be a negative score because the cost of the room will be greater the user-specified budget, but not so much greater that the room should be excluded from consideration.

If the value of the actual-to-search room rate ratio minus 1 is not less than zero, then at 322, the score for the room rate is set equal to a second weighted factor of this value. This will be a positive number, reflecting the fact that the actual cost of the room is less than the user's budgeted amount. Because overly expensive properties are excluded from consideration, it is expected that for most searches there will be a greater number of less expensive rooms than more expensive rooms (in each instance as compared to the user's budgeted room rate) returned in the results. For these less expensive rooms, the larger the difference between the actual cost of the room and user's budgeted amount, the greater the room score, up to the capped value, X.

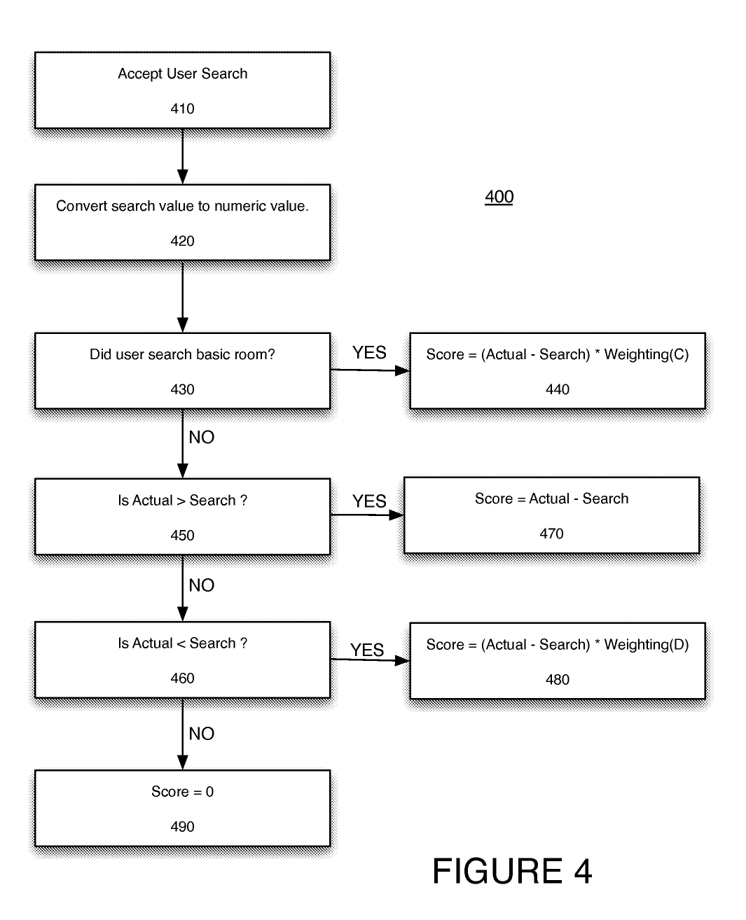

Turning now to FIG. 4, an example of a process 400 for the computation of a score for an accommodation property room type and view is illustrated. Upon receiving the user-specified preferences as part of a search query 410, scoring respective accommodation properties according to the room type preferences first involves assigning numeric values from Table 6 to the user-specified preferences 420. In this regard, numeric values for preferences such as number of bedrooms, view, room type, etc., can be assigned.

For each search, the process then determines whether or not the user has specified a “base room” search 430. Base rooms may vary from property to property, but here it is the user preference for a base room that it evaluated. If the user has specified a preference for a base room, then the score assigned to the candidate property's base room is a weighted factor of the difference between the numeric values of the property's base room and the user-specified base room 440. That is, the candidate property is assessed to determine its individual base room, and a numeric value for same is retrieved from Table 6. Next the difference between the numeric value of the candidate property's base room and the numeric value of a user-specified base room is computed and the difference multiplied by a weighting to arrive at the room score for the subject candidate room.

If the user is not searching for a base room (i.e., if the user is seeking a premium room or other accommodation) then at 450, 460 a determination is made as to whether the numeric value for the actual room type under consideration is greater than or less than, respectively, the numeric value for the desired room type. If greater than, then the difference between the numeric values of the actual and the desired room types is used as the room type score 470. Otherwise if less than, a second weighted difference between the numeric values of the actual and the desired room types is used as the room type score 480. If the numeric values of the actual room type and desired room type are equal (indicating that the candidate room is the type of room the user is seeking), zero is used as the room type score 490. Thus, process 400 over-weights a negative score associated with room types that are believed to be worse (or less desirable) than that which the user specified in his/her search criteria. Note that although process 400 was described in the context of room types, the same process may be used to score room views.

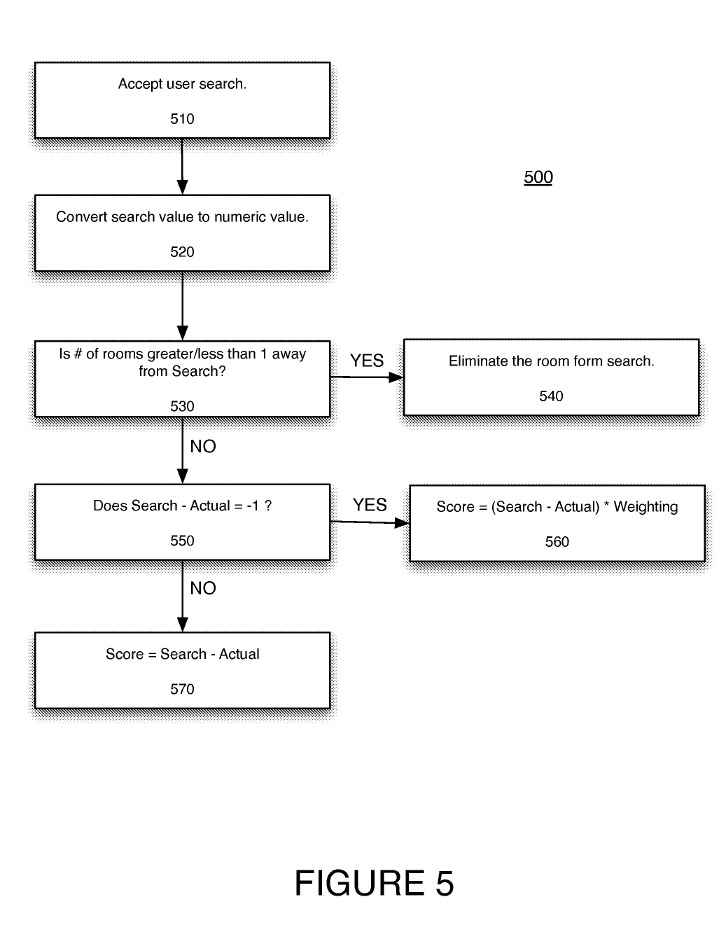

FIG. 5 illustrates an example of a process 500 for computing a room score based on the number of bedrooms in (or associated with) the room. Upon receiving the user-specified preferences for number of bedrooms as part of a search query 510, scoring respective rooms according to the number of bedrooms first involves assigning numeric values from Table 6 to the user-specified preferences 520.

For each candidate room, the process then determines whether or not the candidate room has more or less than one bedroom difference from the user-specified number of bedrooms 520. If so, the room is eliminated from consideration 540. This is because it is believed that user-specified preferences with regard to the number of bedrooms are believed to be relatively inflexible. While a user interested in a studio room may be willing to consider a 1 bedroom room, it is very unlikely that user would be willing to consider a room having 2 or more bedrooms. Likewise, a user that requires 2 bedrooms is unlikely to even consider a studio room. Hence, this filter criterion is applied.

For candidate rooms that are within 1 bedroom of the user-specified preference, the difference between the numeric values assigned to the user-specified room and the candidate room is determined 550. If the result is −1 (indicating that the candidate room has fewer bedrooms that were specified by the search criteria), the room score is set as a weighted factor of the difference between the numeric values assigned to the user-specified room and the candidate room 560. If however, the result of step 550 is not −1, then the room score is set as the difference between the numeric values assigned to the user-specified room and the candidate room 570.

Computations similar to those discussed above may be used for user-specified criteria such as accommodation property ratings, amenities, or other criteria. Where no preference has been specified by a user in a particular category, the scoring may be bypassed.

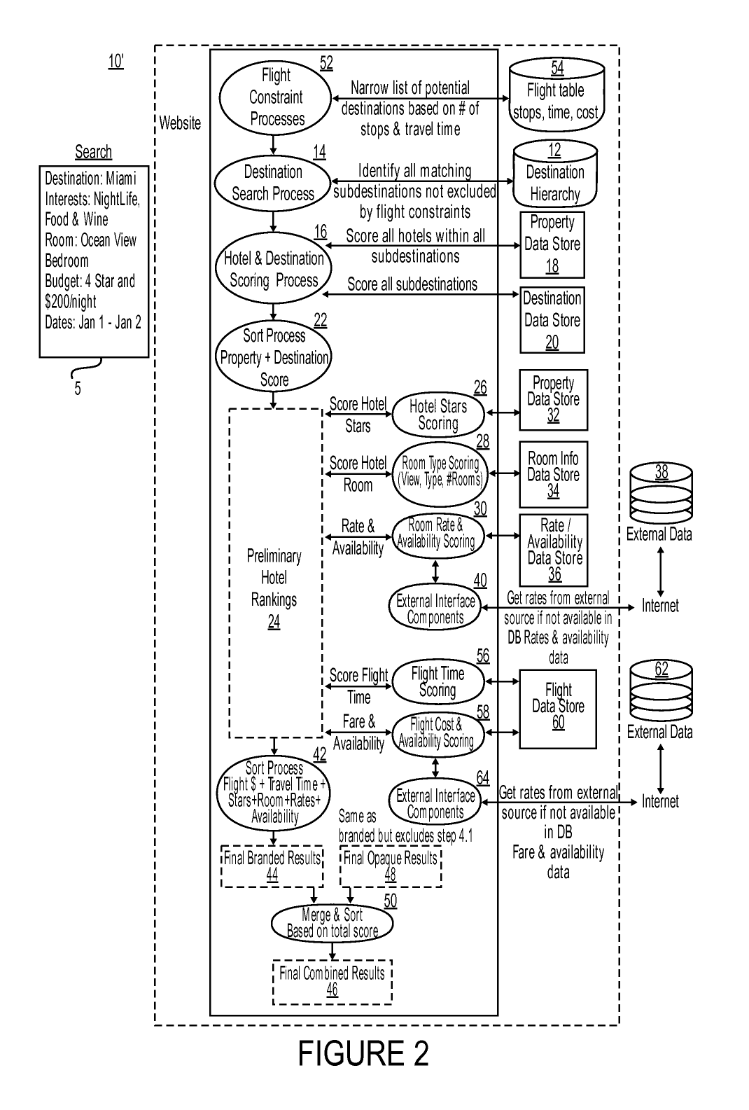

Above it was indicated that flight preferences could, if desired, be included as part of a user's search criteria. FIG. 2 shows a process 10′ that accommodates same. Desired flight preferences such as the maximum number of stops, total flight time, departure/arrival airports/dates, etc. may be solicited from the user as part of a flight constraint process 52. These criteria may be applied against flight information obtained from a flight database 54 and used to eliminate flights that do not satisfy some or all of the criteria. The flight database 54 may be one or more databases and in some cases may be third party databases accessed through appropriate application programming interfaces.

Once a list of candidate flights that meet the filter criteria have been developed, the process 10′ proceeds to develop a list of preliminary accommodation property rankings 24 as before. This time, however, once the accommodation properties have been scored according to room types, rates, availability, etc., they are also scored according to how well candidate flights that would accommodate stays at the properties fit within the user's specified travel preferences. For example, the flight time, flight cost 58, and other factors of accommodating flights may be scored against the user's specified flight cost ands other preferences, much in the same manner as discussed above for various room characteristics. Numeric values for flight information used in such scorings may be stored in a flight data store 60 and this data store may be periodically updated from external data sources 62 via appropriate interfaces 64. This way, up-to-date flight cost information, etc., will inform the preliminary accommodation property results.

Once the preliminary results are available, producing the final ranked list(s) of results proceeds in the fashion discussed above. This time, however, when the results are presented to the user, the corresponding flight information that was used in determining a ranking may be presented along with the accommodation information. As was the case for accommodation properties, flight information may be presented transparently or opaquely, and a given result may be made up of any combination of transparent or opaque flight information and transparent or opaque accommodation property information.

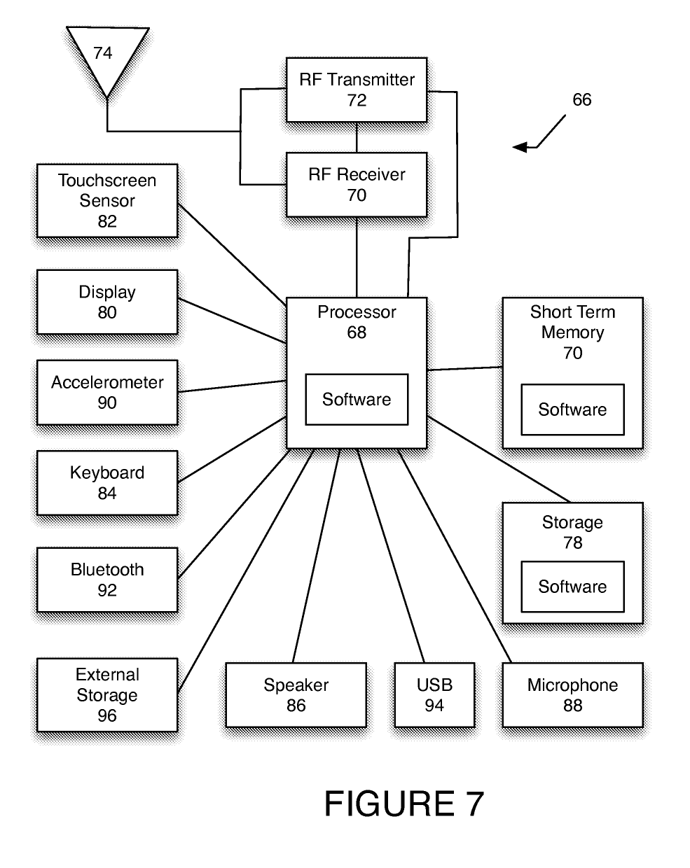

From the above discussion it should be apparent that instantiations of the methods or processes described herein may be executable as computer software (i.e., computer readable instructions) on various computer-based (or processor-based) devices. Such devices may include any electronic device capable of performing the actions described above (using suitable programming) and, where applicable, processing the information for display so as to properly convey the information. Examples of such devices include desktop computers, laptop computers, cellphones, smart phones, tablet computers, computer game consoles, portable computer gaming consoles, media players, portable media players, other mobile devices, and the like. FIG. 7 shows one example of such a device 66 in the form of an electronic device.

Device 66 includes a processor 68. Processor 68 may control the overall functions of the electronic device such as running applications and controlling peripherals. Processor 68 may be any type of processor and may communicate with RF receiver 70 and RF transmitter 72 to transmit and receive wireless signals (e.g., via antenna 74) such as cellular, Bluetooth, Wi-Fi, WiLAN, or other communication signals. Processor 68 may use short-term memory 76 to store operating instructions and to help in the execution of the operating instructions (e.g., such as the temporary storage of calculations and the like). Processor 68 may also use non-transitory storage 78 to store and read instructions, files, and other data that requires long term, non-volatile storage.

Processor 68 may communicate and control other peripherals, such as display 80 with associated touch screen sensor 82. Processor 68 causes images to be displayed on display 80 and receives input from the touch screen sensor 82 when a user presses on the touch-screen display. In some examples, touch screen sensor 82 may be a multi-touch sensor capable of distinguishing and processing gestures.

Processor 68 may receive input from a physical keyboard 84. In other examples, the device 66 may utilize a touch screen keyboard using display 80 and touch screen sensor 82. Processor 68 may produce audio output and other alerts that are played on the speaker 86. Microphone 88 may be used as an input device for processor 68 to receive commands using voice-processing software.

Accelerometer 90 provides input on the motion of the device 66 to processor 68. Accelerometer 90 may be used in motion sensitive applications, or, for example, in connection with scrolling content using tilting gestures, etc. Bluetooth module 92 may be used to communicate with Bluetooth-enabled external devices. USB port 94 enables external connections to other devices (e.g., mice or other cursor control devices) supporting the USB standard and charging capabilities. USB port 94 may include all the functionality to connect to, and establish a connection with, an external device over USB. External storage module 96 may include any form of removable physical storage media such as a flash drive, micro SD card, SD card, Memory Stick, and the like. External storage module 96 may include all the functionality needed to interface with these media.

Thus, the various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some example embodiments, the processor or processors may be located in a single location, while in other embodiments the processors may be distributed across a number of locations.

Where instantiated as software, such software may be written in any form of programming language, including compiled or interpreted languages, and it may be deployed in any form, including as a stand-alone program or as a module, subroutine, or other unit suitable for use in a computing environment. The software may be deployed to be executed on one computer system or on multiple computer systems at one site or distributed across multiple sites and interconnected by a communication network. At times, the software may be embodied on a computer program product, for example as a computer program tangibly embodied in an information carrier such as a non-transitory machine-readable medium, for execution by, or to control the operation of, a data processing apparatus such as a programmable processor, a computer, or multiple computers. Example embodiments may also be implemented in digital electronic circuitry, in firmware, or in various combinations of circuitry, firmware and software.

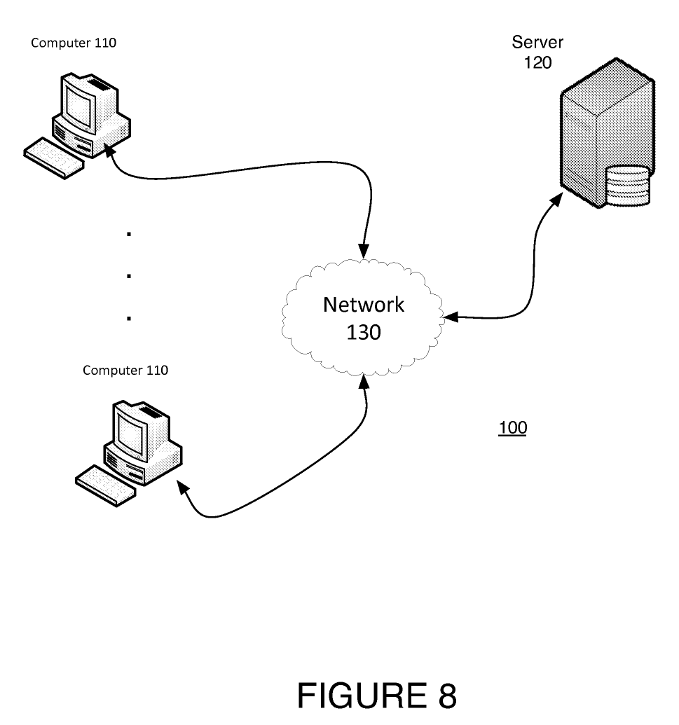

In some embodiments of the present invention, operations may be performed by one or more programmable processors executing a computer program to perform functions by operating on input data and generating output. The above-mentioned server on which an instantiation of a website through which the methods of making travel recommendations described herein may be accessed is an example of such a system and FIG. 8 illustrates an example of a computing environment 100 that includes same. In this example, server 120, on which the travel recommendation website is hosted, is accessible through network 130 by one or more client computer systems 110. Network 130 may be the Internet or other computer network or network of networks. Server 130 may include its own data stores or the data stores may be located remotely from server 130 and be accessible though network 130. As indicated below, server 130 may include a conventional web server along with application software to implement the web site features and functionalities described herein.

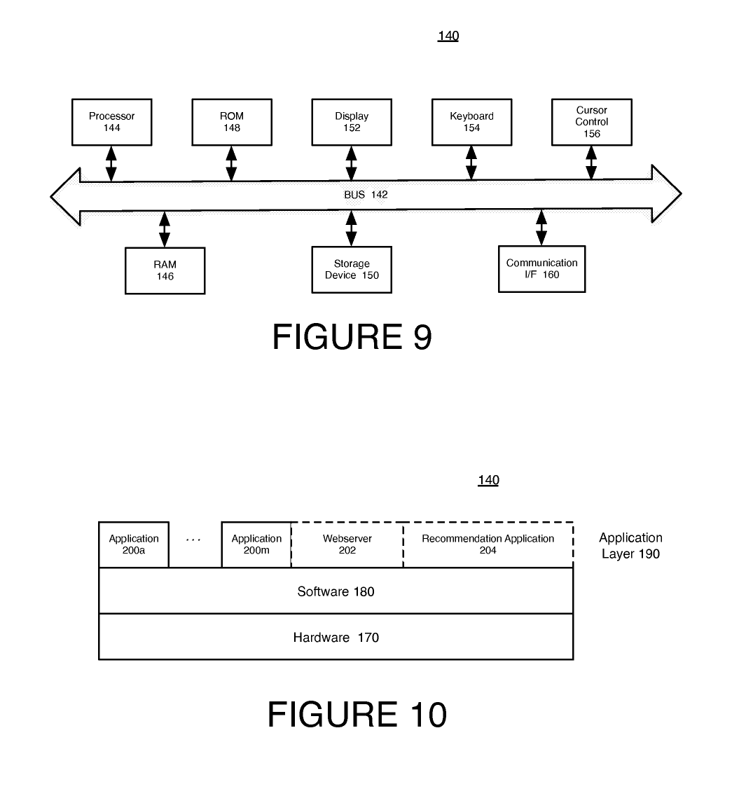

Computing system 100 thus may include clients and servers. A client and server are generally remote from each other and typically interact through a communication network (such as network 130). The relationship of client and server arises by virtue of computer programs running on the respective computers and having a client-server relationship to each other. Clients 110 and servers 120 are both examples of computing machines, an example of which is shown in FIG. 7 and further examples of which are illustrated in FIGS. 9 and 10.

FIG. 9 provides an example of a computer system 140 that is representative of any of the computer systems or servers discussed herein. Note, not all of the various computer systems may have all of the features of computer system 140. For example, certain of the servers discussed above may not include a display inasmuch as a client computer communicatively coupled to the server may provide the display function. Such details are not critical to the present invention.

Computer system 140 includes a bus 142 or other communication mechanism for communicating information, and a processor 144 coupled with the bus for processing information. Computer system 140 also includes a main memory 146, such as a random access memory (RAM) or other dynamic storage device, coupled to the bus for storing information and instructions to be executed by the processor. Main memory 146 also may be used for storing temporary variables or other intermediate information during execution of instructions to be executed by processor 144. Computer system 140 further includes a read only memory (ROM) 148 or other static storage device coupled to the bus for storing static information and instructions for the processor 144. A storage device 150, which may be one or more of a hard disk, flash memory-based storage medium, or other non-transitory storage medium, is provided and coupled to the bus 142 for storing information and instructions (e.g., operating systems, applications programs and the like).

Computer system 140 may be coupled via the bus 142 to a display 152, such as a liquid crystal or light emitting diode display, for displaying information to a user. An input device 154, such as a keyboard including alphanumeric and other keys, is coupled to the bus 142 for communicating information and command selections to the processor. In some embodiments, the keyboard will be a software construct rendered via a touch screen display 152. Another type of user input device is cursor control device 156, such as a mouse, a trackball, or cursor direction keys for communicating direction information and command selections to processor 144 and for controlling cursor movement on the display. Where a touch screen display is used, cursor control functions may be implemented using finger-based gestures directly on the display. Other user interface devices, such as microphones, speakers, etc. are not shown in detail but may be involved with the receipt of user input and/or presentation of output.

The processes referred to herein may be implemented by processor 144 executing appropriate sequences of computer-readable instructions contained in main memory 146. Such instructions may be read into main memory from another computer-readable medium, such as storage device 150, and execution of the sequences of instructions contained in the main memory causes the processor to perform the associated actions. In alternative embodiments, hard-wired circuitry or firmware-controlled processing units (e.g., field programmable gate arrays) may be used in place of or in combination with processor 144 and its associated computer software instructions to implement the invention. The computer-readable instructions may be rendered in any computer language.

In general, the flow diagrams discussed herein are intended to be illustrative of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying” or the like, refer to the action and processes of an appropriately programmed computer system, such as computer system 140 or similar electronic computing device, that manipulates and transforms data represented as physical (electronic) quantities within its registers and memories into other data similarly represented as physical quantities within its memories or registers or other such information storage, transmission or display devices.

Computer system 140 also includes a communication interface 160 coupled to the bus 142. Communication interface 160 provides a two-way data communication channel with a computer network, such as network 130 in FIG. 8, which provides connectivity to and among the various devices discussed above. For example, communication interface 160 may be a local area network (LAN) card (wired and/or wireless) to provide a data communication connection to a compatible LAN, which itself is communicatively coupled to the Internet through one or more Internet service provider networks. The precise details of such communication paths are not critical to the present invention. What is important is that computer system 140 can send and receive information through the communication interface and in that way communication with other computer systems are possible. Computer system 140 may also include additional capabilities and facilities, such as a power unit, which may comprise a battery, a power port, one or more antennae, one or more data ports, and one or more wireless communication modules.

The various databases described herein are computer-based record keeping systems. Stated differently, these databases are each a combination of computer hardware and software that act together to allow for the storage and retrieval of information (data). Accordingly, they may resemble computer system 140, and are often characterized by having storage mediums capable of accommodating significant amounts of information.

FIG. 10 illustrates computer system 140 from the point of view of its software architecture. Computer system 140 may be any of the clients or servers referred to above, with appropriate applications comprising a software application layer 190. The various hardware components of computer system 140 are represented as a hardware layer 170. An operating system 180 abstracts the hardware layer and acts as a host for various applications 200a-200m, that run on computer system 140. In the case of a server, the operating system may act as a host for a recommendation application 204, which is configured to perform the processes described above (e.g., to provide travel recommendations in response to user input). For a server, the operating system may also host a web server application 202, which provides access from the client devices via web browsers, etc. The precise hardware configuration of the hosting and other device resources is generally not critical to the present invention.

In the foregoing description, certain flow diagrams have been shown and processes described in relation to those flow diagrams that provide a reference for discussion purposes. In an actual implementation of the methods of the present invention, the steps can comprise event-driven routines that can run in parallel and can be launched and executed other than as shown by the simple depiction in the flow diagrams. In short, the particular order of the steps in the flow diagrams is illustrative of the invention, but not limiting of the various permutations that can be achieved in a given embodiment. Accordingly, it is the performance of the steps recited in the claims appended below which is pertinent, and not the order of operation of the steps themselves.

In light of the forgoing discussion it should be apparent that, in addition to the embodiments described above, further embodiments of the present invention may include a computer-based system for recommending vacation properties that includes a processor communicatively coupled to a computer-readable storage device and to a communication interface, the communication interface for receiving one or more user-specified destinations and one or more of: user activity or amenity preferences, room amenity and room type preferences, accommodation quality preferences, and preferred travel dates, and the computer-readable storage device having stored thereon instructions, which when executed by the processor, cause the processor to produce a ranked list of accommodation properties. The ranked list of accommodation properties may be determined by: scoring accommodation properties within each identified sub-destination of the one or more user-specified destinations, each of the accommodation properties scored according to one or more of the user activity or amenity preferences, the room amenity and room type preferences, the accommodation quality preferences, and availabilities during the preferred travel dates. The ranked list of accommodation properties may include both transparent (i.e., non-opaque) and opaque accommodation property results, individual ones of the opaque accommodation property results differing from individual ones of the non-opaque accommodation property results by not including property-identifying information.

The scoring of accommodation properties may involve weighted scorings that limit emphasis on potential outlier accommodation properties deemed to be substantially different from a user's specified preferences in one or more categories. Further, scoring respective accommodation properties according to the room amenity and room type preferences may involve determining, for each respective candidate accommodation property, whether a weighted ratio of a desired rate for a specified amenity and room type preference to an actual rate for the specified amenity and room type preference exceeds a first predetermined threshold and, if so, capping an associated score for amenity and room type preference for the respective candidate accommodation property at the threshold, otherwise determining for the respective candidate accommodation property whether a ratio of the actual rate for the specified amenity and room type preference to the desired rate for a specified amenity and room type preference exceeds a second predetermined threshold and, if so, eliminating the respective candidate accommodation property from consideration, otherwise determining for the respective candidate accommodation property whether a normalized ratio of the actual rate for the specified amenity and room type preference to the desired rate for a specified amenity and room type preference is less than a third predetermined threshold and, if so, using a first weighted version of the normalized ratio of the actual rate for the specified amenity and room type preference to the desired rate for a specified amenity and room type preference as a score for the respective candidate accommodation property, otherwise using a second weighted version of the normalized ratio of the actual rate for the specified amenity and room type preference to the desired rate for a specified amenity and room type preference as a score for the respective candidate accommodation property.

Scoring respective accommodation properties according to room type preferences may involve determining, for each respective candidate accommodation property, whether the room type preference is for a base room and, if so, using a first weighted difference between numerical values for the actual room type and the desired room type as a room type score, otherwise determining whether the numerical value for the actual room type is greater than or less than the numerical value for the desired room type and, if greater than, using a difference between the numerical values of the actual and the desired room type as the room type score, otherwise if less than, using a second weighted difference between the numerical values of the actual and the desired room type as the room type score, otherwise using zero as the room type score.

Still further embodiments of the present invention include a method of providing accommodation recommendations that involves transmitting, from a server operatively coupled to receive user-specified vacation criteria, a ranked list of accommodation recommendations. The ranked list of accommodation recommendations may include both transparent and opaque accommodation property results, individual ones of the opaque accommodation property results differing from individual ones of the transparent accommodation property results by not including property-identifying information,

In various instances, the ranked list of accommodation recommendations may be determined by the server using user-specified destinations and one or more of: user activity or amenity preferences, room amenity and room type preferences, accommodation quality preferences, and preferred travel dates, the server scoring accommodation properties within identified sub-destinations of the one or more user-specified destinations according to one or more of the user activity or amenity preferences, the room amenity and room type preferences, the accommodation quality preferences, and availabilities during the preferred travel dates. Optionally, flight preference information may also be used in computing the ranked list of results.

Scoring of the accommodation properties may involve weighted scorings that limit emphasis on potential outlier accommodation properties deemed to be substantially different from a user's specified preferences in one or more categories. Further, the opaque accommodation property results included in the ranked list may be accompanied by categorized scores for one or more of the user activity or amenity preferences, the room amenity and room type preferences, and the accommodation quality preferences, thus acting as enticements for users to trust and, possibly purchase, said results.

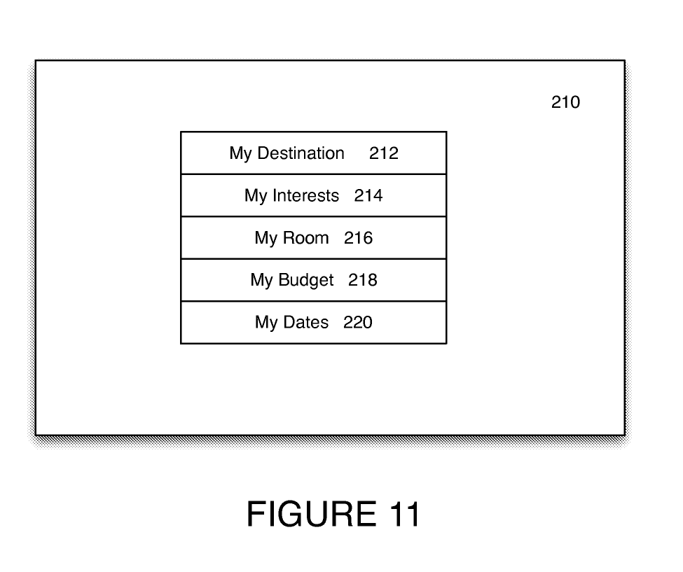

FIG. 11 illustrates an example of a user interface 210 for soliciting user preference information in accordance with embodiments of the present invention. The interface may be rendered as a web page, web form or other object in a window or similar construct of a web browser application running on a client computer system 110 in response to the computer system contacting server 120. The interface includes text boxes or other means for the user to specify his/her preferences for destinations 212, interests 214, room type/amenities/number of bedrooms 216, room budget/accommodation rating 218 and preferred travel dates 220. In some cases, flight preference information may also be solicited through this interface. Text boxes are not the only means of capturing the user preference information and in some cases the information may be obtained by providing the user with lists that include check boxes or radio buttons which can be selected. This is especially useful for capturing information such as room type/amenity/number of bedrooms preferences, interests, etc. as by limiting a user to selecting from pre-established lists, the scoring process is made easier. In addition, dates may be captured through the use of interactive calendar widgets.

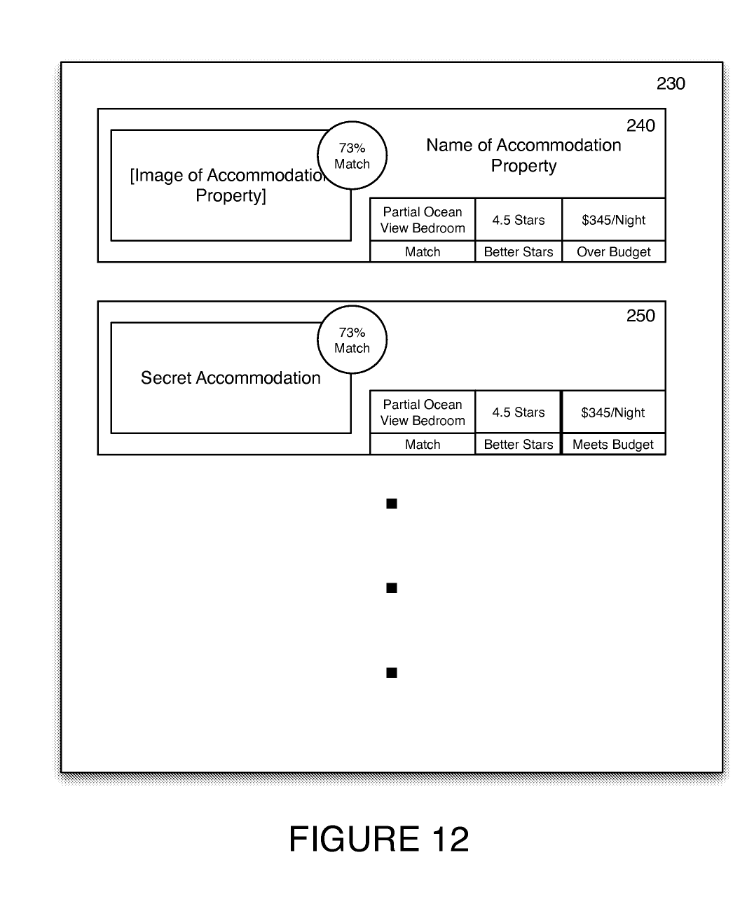

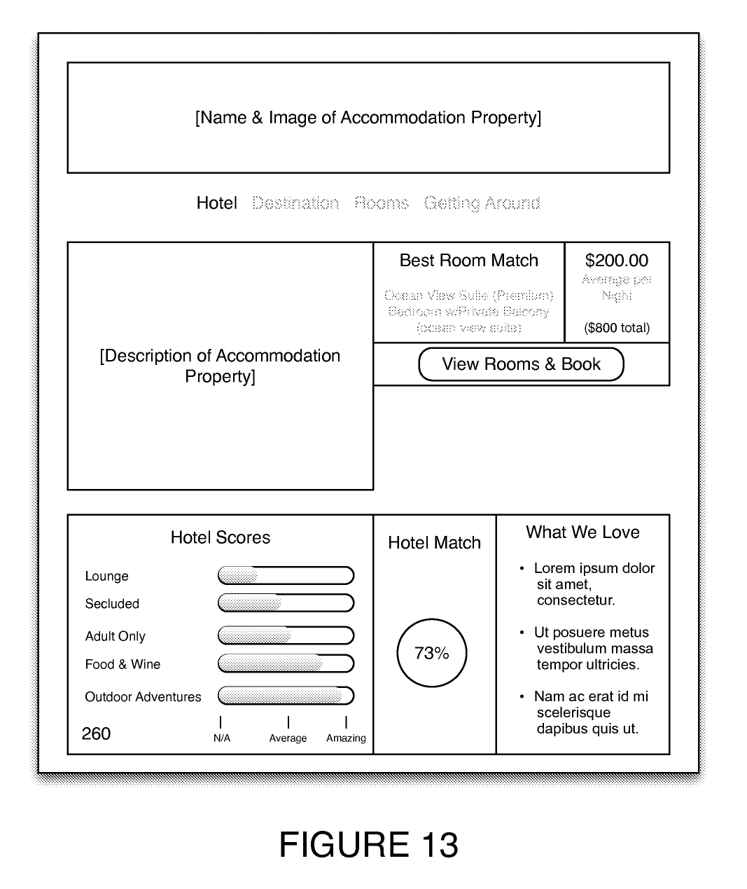

FIG. 12 illustrates an example of a portion of a ranked list 230 of accommodation properties returned to a user as search results in accordance with an embodiment of the present invention. List 230 includes transparent search result 240 and opaque search result 250. Notice that transparent search result 240 includes the name of the accommodation property, which opaque search result 250 does not. The opaque result may be for the same room at the same property as the transparent result, a different room at the same property as the transparent result or a different room at a different property than the transparent result. Both search results include information that allows the user to better understand why the particular accommodation property was selected as a search result. For example, scores in various categories (hotel, destination, room type, accommodation rating, room cost, etc.) are presented to the user (e.g., as percentage matches to the user's specified preferences). As shown in FIG. 13, the user can obtain further information regarding these scores, for example by hovering a cursor over a hotspot associated with one of the scores, which will cause a pop-up window 260 to appear. The pop-up window may include a detailed report that provides the accommodation property score (in either an absolute or relative fashion) in each of the user's specified interest categories.

The present user interface may also include facilities for users to further explore the accommodation properties returned in the ranked lists, to provide feedback regarding how well or poorly the suggested properties aligned with the user's expressed interests, and for purchasing stays at these accommodations. Where flight information is included as part of the travel recommendation, options to purchase flights may likewise be provided.

Thus, methods and systems for travel recommendations and, in particular, such methods and systems as provide ranked recommendations that take into account user-specified preferences in a plurality of categories and which include both transparent and opaque results have been described.

1. A method of determining recommended vacation properties, comprising:
receiving, at a processor-based computer system, one or more user-specified destinations and one or more of: user activity or amenity preferences, room amenity and room type preferences, accommodation quality preferences, and preferred travel dates;
for each of the one or more user-specified destinations, the processor-based computer system:
identifying a plurality of sub-destinations corresponding to a received user-specified destination from a destination database, and for each corresponding sub-destination,
scoring (i) a plurality of accommodation properties according to received user activity or amenity preferences, and (ii) the sub-destination according to received user activity or amenity preferences, to produce preliminary accommodation property and sub-destination scores, and
sorting the accommodation properties according to the preliminary accommodation property and sub-destination scores to produce preliminary accommodation rankings;
for a plurality of accommodation properties of the preliminary accommodation rankings,
scoring respective accommodation properties according to one or more of received room amenity and room type preferences, accommodation quality preferences, and availability during the preferred travel dates, and
sorting the plurality of accommodation properties according to results of the scoring to produce final accommodation property rankings; and
presenting, for user review and selection, the final accommodation property rankings.

2. The method of claim 1, further comprising, including with the final accommodation property rankings, a set of final opaque accommodation property results, individual ones of the opaque accommodation property results differing from individual ones of the final accommodation property rankings by not including property-identifying information.

3. The method of claim 2, wherein individual ones of the final opaque accommodation property results are presented in ranked order along with individual ones of the final accommodation property rankings in a unified list.

4. The method of claim 2, wherein the final opaque accommodation property results are determined by the processor-based computer system identifying, for the user-specified destinations, corresponding sub-destinations from the destination database, for each corresponding sub-destination, scoring the sub-destination and a plurality of accommodation properties having opaque listings within each sub-destination according to received user activity or amenity preferences to produce a preliminary opaque accommodation property score, sorting the opaque accommodation properties according to respective opaque accommodation property scores to produce preliminary opaque accommodation property rankings, for a plurality of opaque accommodations of the opaque accommodation property rankings, scoring respective opaque accommodation properties according to one or more of received room amenity and room type preferences, accommodation quality preferences, and received availability during the preferred travel dates; and sorting results of the scoring.

5. The method of claim 4, wherein individual ones of the final opaque accommodation property results are presented in ranked order along with individual ones of the final accommodation property rankings in a unified list.

6. The method of claim 1, wherein the scorings of accommodation properties comprises weighted scorings which limit emphasis on potential outlier accommodation properties which are deemed to be different from a user's specified preferences in one or more categories.

7. The method of claim 1, wherein scoring respective accommodation properties according to received room amenity and room type preferences, comprises:
determining, for each respective candidate accommodation property, whether a weighted ratio of a desired rate for a specified amenity and room type preference to an actual rate for the specified amenity and room type preference exceeds a first predetermined threshold and, if so, capping an associated score for amenity and room type preference for the respective candidate accommodation property at the threshold, otherwise
determining for the respective candidate accommodation property whether a ratio of the actual rate for the specified amenity and room type preference to the desired rate for a specified amenity and room type preference exceeds a second predetermined threshold and, if so, eliminating the respective candidate accommodation property from consideration, otherwise
determining for the respective candidate accommodation property whether a normalized ratio of the actual rate for the specified amenity and room type preference to the desired rate for a specified amenity and room type preference is less than a third predetermined threshold and, if so, using a first weighted version of the normalized ratio of the actual rate for the specified amenity and room type preference to the desired rate for a specified amenity and room type preference as a score for the respective candidate accommodation property, otherwise
using a second weighted version of the normalized ratio of the actual rate for the specified amenity and room type preference to the desired rate for a specified amenity and room type preference as a score for the respective candidate accommodation property.

8. The method of claim 1, wherein scoring respective accommodation properties according to received room type preferences comprises:
determining, for each respective candidate accommodation property, whether the received room type preferences are for a base room and, if so, using a first weighted difference between a numeric value for the actual room type and a numeric value for a desired room type as a room type score, otherwise
determining whether the numeric value for the room type is greater than or less than the numeric value for the desired room type and,
if greater than, using a difference between the numeric values of the actual and the desired room types as the room type score, otherwise
if less than, using a second weighted difference between the numeric values of the actual and the desired room types as the room type score, otherwise
using zero as the room type score.

9. A computer-based system for recommending vacation properties, comprising:
a processor communicatively coupled to a computer-readable storage device and to a communication interface, the communication interface for receiving one or more user-specified destinations and one or more of: user activity or amenity preferences, room amenity and room type preferences, accommodation quality preferences, and preferred travel dates, and the computer-readable storage device having stored thereon instructions, which when executed by the processor, cause the processor to produce a ranked list of accommodation properties, the ranked list of accommodation properties determined by:
scoring accommodation properties within each identified sub-destination of the one or more user-specified destinations, each of the accommodation properties scored according to one or more of received user activity or amenity preferences, received room amenity and room type preferences, received accommodation quality preferences, and received availabilities during the preferred travel dates, wherein
the ranked list of accommodation properties includes both non-opaque and opaque accommodation property results, individual ones of the opaque accommodation property results differing from individual ones of the non-opaque accommodation property results by not including property-identifying information.

10. The system of claim 9, wherein the scorings of accommodation properties comprises weighted scorings which limit emphasis on potential outlier accommodation properties deemed to be different from a user's specified preferences in one or more categories.

11. The system of claim 9, wherein scoring respective accommodation properties according to received room amenity and room type preferences, comprises:
determining, for each respective candidate accommodation property, whether a weighted ratio of a desired rate for a specified amenity and room type preference to an actual rate for the specified amenity and room type preference exceeds a first predetermined threshold and, if so, capping an associated score for amenity and room type preference for the respective candidate accommodation property at the threshold, otherwise
determining for the respective candidate accommodation property whether a ratio of the actual rate for the specified amenity and room type preference to the desired rate for a specified amenity and room type preference exceeds a second predetermined threshold and, if so, eliminating the respective candidate accommodation property from consideration, otherwise
determining for the respective candidate accommodation property whether a normalized ratio of the actual rate for the specified amenity and room type preference to the desired rate for a specified amenity and room type preference is less than a third predetermined threshold and, if so, using a first weighted version of the normalized ratio of the actual rate for the specified amenity and room type preference to the desired rate for a specified amenity and room type preference as a score for the respective candidate accommodation property, otherwise
using a second weighted version of the normalized ratio of the actual rate for the specified amenity and room type preference to the desired rate for a specified amenity and room type preference as a score for the respective candidate accommodation property.

12. The system of claim 9, wherein scoring respective accommodation properties according to received room type preferences comprises:
determining, for each respective candidate accommodation property, whether received room type preferences are for a base room and, if so, using a first weighted difference between numerical values for an actual room type and a desired room type as a room type score, otherwise
determining whether a numerical value for the actual room type is greater than or less than a numerical value for the desired room type and,
if greater than, using a difference between the numerical values of the actual and the desired room type as the room type score, otherwise
if less than, using a second weighted difference between the numerical values of the actual and the desired room type as the room type score, otherwise
using zero as the room type score.

13. A method of providing accommodation recommendations, comprising:
transmitting, from a server operatively coupled to receive user-specified vacation criteria, a ranked list of accommodation recommendations, the ranked list of accommodation recommendations including both non-opaque and opaque accommodation property results, individual ones of the opaque accommodation property results differing from individual ones of the non-opaque accommodation property results by not including property-identifying information, wherein
the ranked list of accommodation recommendations is determined by the server using user-specified destinations and one or more of: user activity or amenity preferences, room amenity and room type preferences, accommodation quality preferences, and preferred travel dates,
the server scoring accommodation properties within identified sub-destinations of the one or more user-specified destinations according to one or more of received user activity or amenity preferences, received room amenity and room type preferences, received accommodation quality preferences, and received availabilities during the preferred travel dates.

14. The method of claim 13, wherein the scorings of accommodation properties comprises weighted scorings which limit emphasis on potential outlier accommodation properties deemed to be different from a user's specified preferences in one or more categories.

15. The method of claim 14, wherein the opaque accommodation property results included in the ranked list are accompanied by categorized scores for one or more of received user activity or amenity preferences, received room amenity and room type preferences, and the accommodation quality preferences.
